(19) United States
(12) Patent Application Publication
(10) Pub. No.: US 2016/0091103 A1
(43) Pub. Date: Mar. 31, 2016

(54) AUTOMATIC PRESSURE RELIEF DEVICE FOR WATER PURIFIER

(71) Applicant: Linda Liu, Taichung (TW)

(72) Inventor: Linda Liu, Taichung (TW)

(21) Appl. No.: 14/501,106

(22) Filed: Sep. 30, 2014

(51) Int. Cl. F16K 17/04

(52) U.S. Cl. CPC F16K 17/0406

(57) ABSTRACT

A pressure relief device used in a water purifier for ejecting abnormal water pressure is disclosed. The device includes a T-shaped tube composed of a connecting tube and a valve tube. The connecting tube has a main channel. The valve tube is formed with a connecting hole communicating with the main channel and an inner hole communicating with the connecting hole. The connecting hole is less than the inner hole in diameter to form a step therebetween. A plug is fastened to an outer end of the valve tube and has a trough therein. The trough communicates with the inner hole. A ball is placed in the inner hole on the step to normally bung the connecting hole. A compression spring is placed in the inner hole and clamped between the ball and the plug to elastically push the ball.

### BACKGROUND OF THE INVENTION

1. Technical Field

The invention relates to water purifiers, particularly to pressure relief devices of water purifiers.

2. Related Art

Water is one of requisite elements of mankind. With the development of industries, however, water pollution becomes more and more serious. As a result, many families would use a water purifier for obtaining clean water. Some water purifiers require a pump to add water pressure. Conventional pumped water purifiers are not equipped with an automatic pressure relief device to eject abnormal pressure. However, the water channel will burst if it is jammed to cause abnormal pressure.

### SUMMARY OF THE INVENTION

An object of the invention is to provide an automatic pressure relief device for a water purifier, which can automatically eject water when the water pressure in the water channel is higher than a threshold and can automatically restore to a closed status when the water pressure is normal.

The automatic pressure relief device of the invention includes a T-shaped tube composed of a connecting tube and a valve tube. The connecting tube has a main channel. The valve tube is formed with a connecting hole communicating with the main channel and an inner hole communicating with the connecting hole. The connecting hole is less than the inner hole in diameter to form a step therebetween. A plug is fastened to an outer end of the valve tube and has a trough therein. The trough communicates with the inner hole. A ball is placed in the inner hole on the step to normally bung the connecting hole. A compression spring is placed in the inner hole and clamped between the ball and the plug to elastically push the ball.

### BRIEF DESCRIPTION OF THE DRAWINGS

FIG. 1 is an exploded view of the first embodiment of the invention;

FIG. 2 is a cross-sectional view of the first embodiment of the invention;

FIG. 3 is an exploded view of the second embodiment of the invention;

FIG. 4 is a cross-sectional view of the second embodiment of the invention;

FIG. 5 is a schematic view of the first embodiment of the invention and a water purifier;

FIG. 6 is a cross-sectional view of FIG. 5;

FIG. 7 is a schematic view showing automatic pressure relief;

FIG. 8 is a schematic view of the second embodiment of the invention and a water purifier;

FIG. 9 is a cross-sectional view of FIG. 8;

FIG. 10 is a schematic view of the invention applied in a purifier cover with multiple tubes;

FIG. 11 is a schematic view of the invention applied in a purifier with multiple tubes;

FIG. 12 is a schematic view of the invention applied in a water purifying system; and

FIG. 13 is a schematic view of the invention applied in a RO (reverse osmosis) water purifying system.

### DETAILED DESCRIPTION OF THE INVENTION

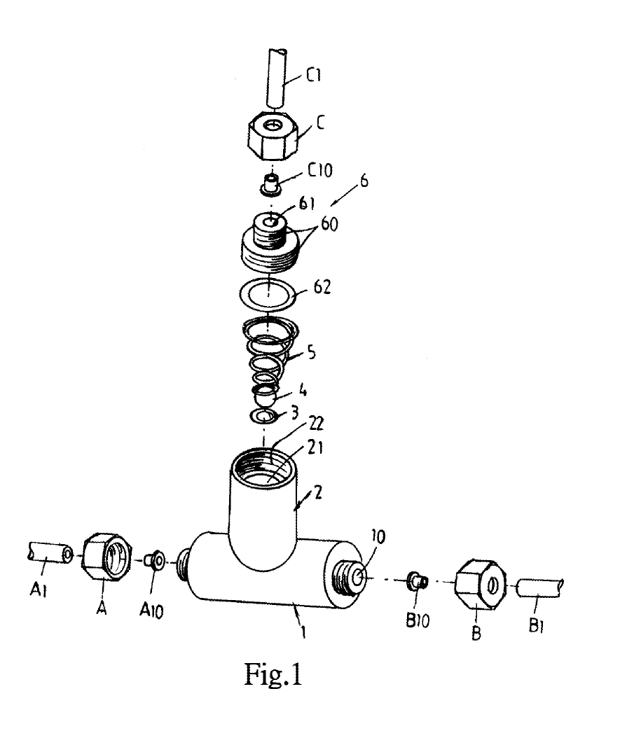

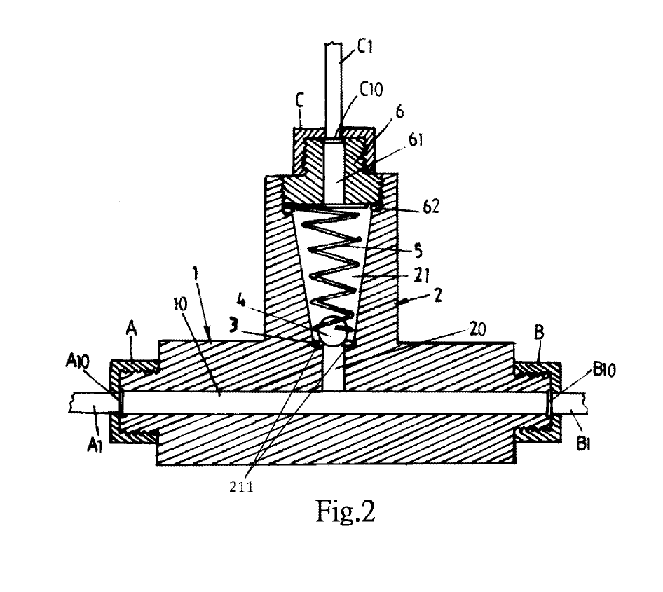

Please refer to FIGS. 1 and 2. The invention includes a connecting tube 1 and a valve tube 2. The valve tube 2 is perpendicularly connected to the connecting tube 1 to form a T-shaped tube. In this embodiment, the valve tube 2 and the connecting tube 1 are integratedly formed into a single piece. The connecting tube 1 has a main channel 10 therein. The valve tube 2 is formed with a connecting hole 20 communicating with the main channel 10 and an inner hole 21 communicating with the connecting hole 20. The connecting hole 20 and the inner hole 21 axially pass through the valve tube 2 to form an ejection channel.

Preferably, the inner hole 21 is of a conic shape. The conic inner hole 21 is tapered off toward the connecting hole 20. A diameter of the connecting hole 20 is less than the smallest diameter of the inner hole 21. Thus a step 211 is formed between the connecting hole 20 and the inner hole 21.

A plug 6 is fastened to an outer end of the valve tube 2. The plug 6 has an axial trough 61 therein. The trough 61 communicates with the inner hole 21. A ball 4, whose diameter is greater than a diameter of the connecting hole 20 and less than the smallest diameter of the inner hole 21, is placed in the inner hole 21 on the step 211 to normally bung the connecting hole 20. Additionally, a compression spring 5 is placed in the inner hole 21 and clamped between the ball 4 and the plug 6 to normally elastically push the ball 4. The compression spring 5 is formed into a conic shape corresponding to the conic inner hole 21. Preferably, an O-ring 3 may be arranged between the compression spring 5 and the step 211 to provide a better sealing effect.

The outer end of the valve tube 2 is formed with an inner thread 22. The plug 6 is formed with an outer thread 60 corresponding to the inner thread 22 of the valve tube 2 so that the plug 6 can be screwed to the valve tube 2. Another O-ring 62 may be arranged between the plug 6 and the valve tube 2.

The connecting hole 20 is completely closed by the ball 4 through elasticity of the compression spring 5 when the water pressure in the main channel 10 of the connecting tube 1 is normal. No water can flow out of the valve tube 2. When the water pressure in the main channel 10 is higher than an elastic threshold of the compression spring 5 because the main channel 10 is jammed, the ball 4 will press the compression spring 5 to shrink and the connecting hole 20 is temporarily opened. Thus water in the main channel 10 can be ejected through the valve tube 2. The compression spring 5 will automatically push the ball 4 to close the connecting hole 20 again when the water pressure in the main channel 10 restores to a normal status.

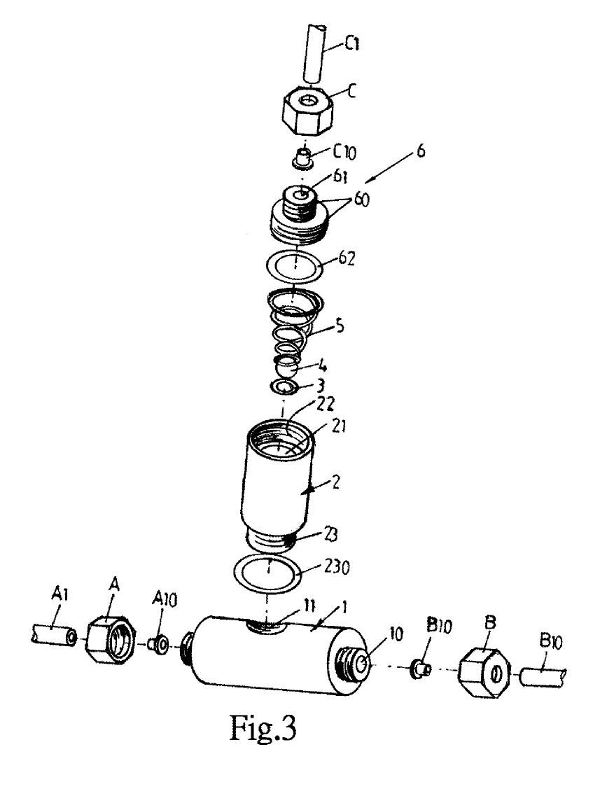

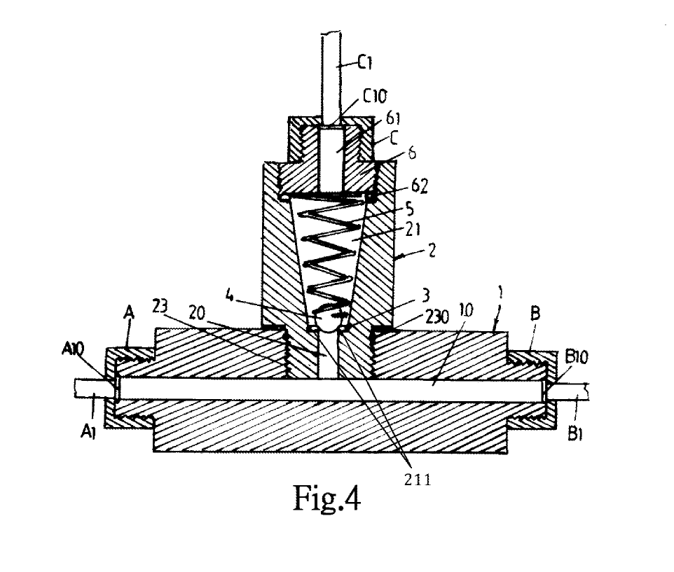

FIGS. 3 and 4 show another embodiment of the invention. In this embodiment, the connecting tube 1 is provided with a threaded hole 11 and the valve tube 2 is provided with a threaded connector 23. Thus the connecting tube 1 and the valve tube 2 can be connected by screwing. Preferably, the threaded connector 23 may be further provided with an O-ring 230 for better sealing.

The elastic threshold of the compression spring 5 can be adjusted by varying the axial position against the valve tube 2. In other words, rotate the plug 6 to make variation of axial position of the plug relative to the valve tube 2.

The conic shape of the compression spring 5 can make elasticity thereof nonlinear. This can progressively increase resistance to movement of the ball 4 when the water pressure in the main channel 10 becomes larger and larger.

Two ends of the connecting tube 1 and the plug 6 are separately provided with nuts A, B and C to connect pipes A1, B1 and C1. The pipes A1, B1 and C1 are separately provided with sealing members A10, B10 and C10 for better sealing.

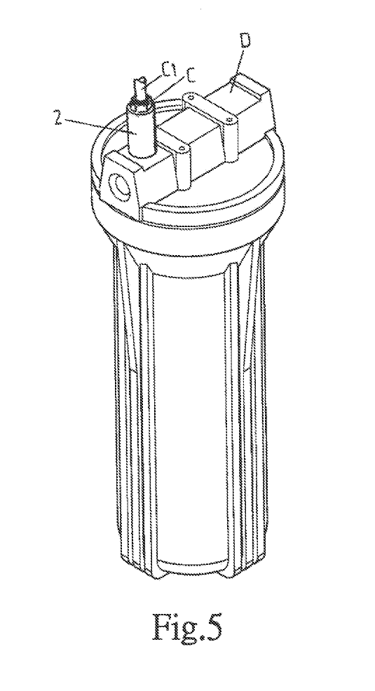

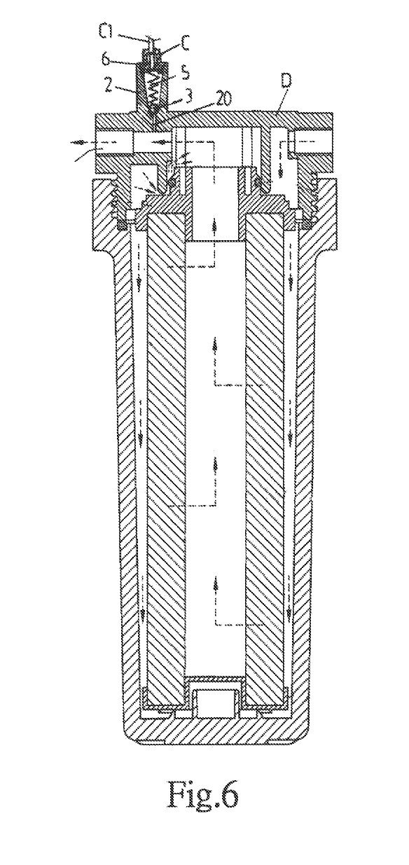

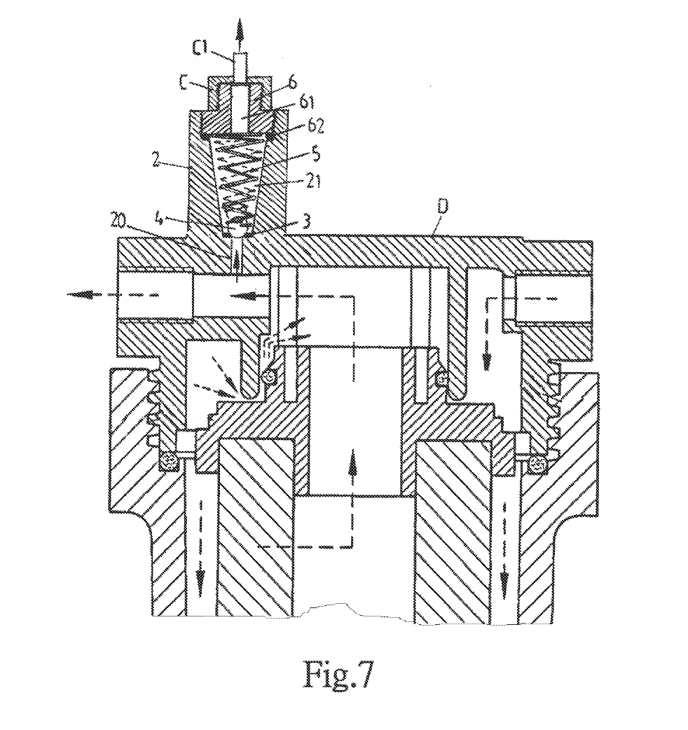

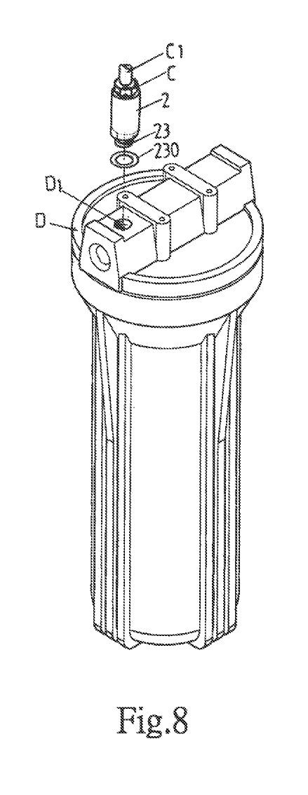

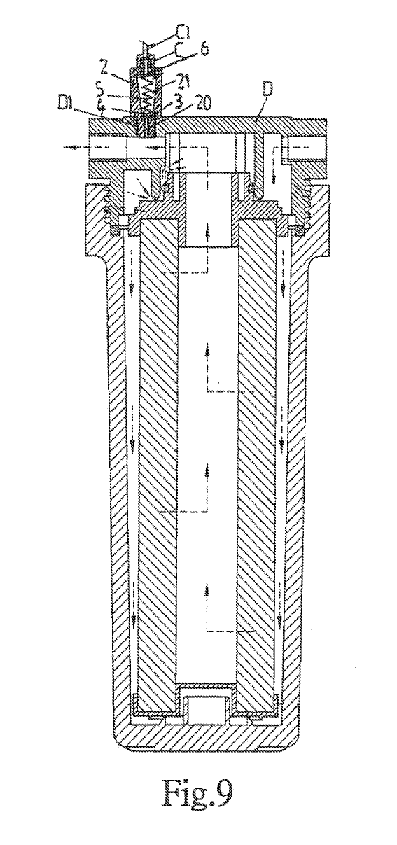

As shown in FIGS. 5-9, when the present invention is applied in a water purifier with a single tube, the valve tube 2 may be integratedly formed with a cover D or the cover D is formed with a threaded hole D1 for connecting the valve tube 2 of the invention. Water can flow through the filter when the water pressure in the filter stays normal. When the water pressure in the filter is high enough, the connecting hole 20 is temporarily opened to eject water through the valve tube 2 and an ejection pipe C1.

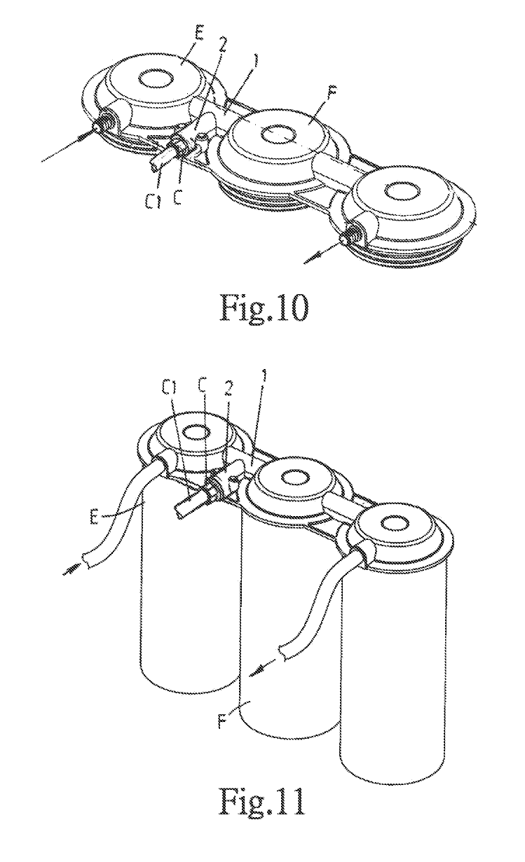

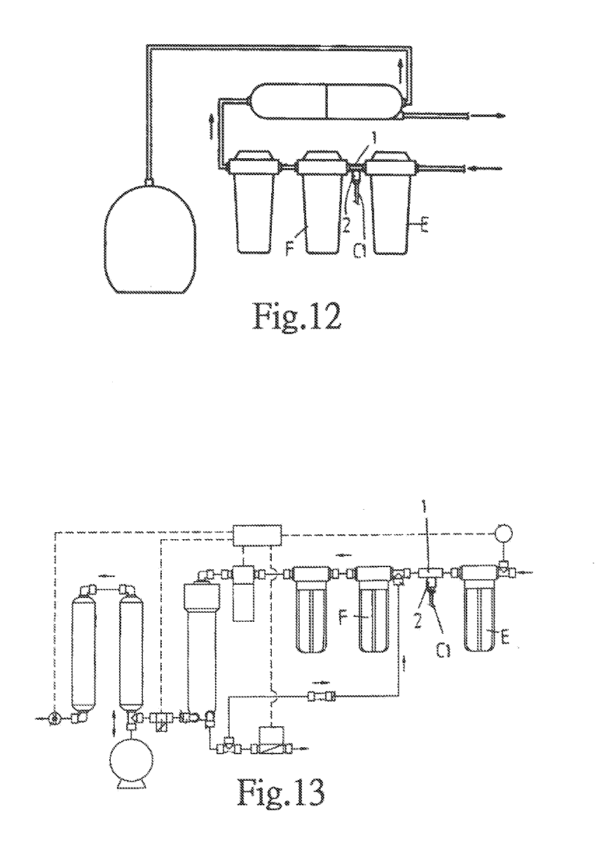

Please refer to FIGS. 10-13. The invention may be applied in a multi-tube purifier or an RO (reverse osmosis) system. The invention can be installed between a first filter E and a second filter F.

It will be appreciated by persons skilled in the art that the above embodiments have been described by way of example only and not in any limitative sense, and that various alterations and modifications are possible without departure from the scope of the invention as defined by the appended claims.

What is claimed is:

1. An automatic pressure relief device for a water purifier, comprising:
a connecting tube, having a main channel;
a valve tube, perpendicularly connected to the connecting tube, being formed with a connecting hole communicating with the main channel and an inner hole communicating with the connecting hole, and the connecting hole being less than the inner hole in diameter to form a step therebetween;
a plug, fastened to an outer end of the valve tube, having a trough therein, and the trough communicating with the inner hole;
a ball, placed in the inner hole on the step to normally bung the connecting hole;
a compression spring, placed in the inner hole, clamped between the ball and the plug to elastically push the ball.

2. The automatic pressure relief device of claim 1, wherein the valve tube and the connecting tube are integratedly formed into a single piece.

3. The automatic pressure relief device of claim 1, wherein the valve tube is screwed to the connecting tube.

4. The automatic pressure relief device of claim 1, further comprising an O-ring between the step and the compression spring.

5. The automatic pressure relief device of claim 1, wherein the inner hole is of a conic shape, and a diameter thereof is tapered off toward the connecting hole.

6. The automatic pressure relief device of claim 5, wherein the compression spring is of a conic shape corresponding to the inner hole.
